(19) United States
(12) Patent Application Publication
(10) Pub. No.: US 2020/0254682 A1
(43) Pub. Date: Aug. 13, 2020

(54) FOAMING TOOL

(71) Applicant: WERKZEUGBAU SIEGFRIED HOFMANN GMBH, Lichtenfels (DE)

(72) Inventors: Johannes SCHUETZ, Bamberg (DE); Jonas BECK, Bamberg (DE); Marcus SCHMIEDECK, Floeha OT Falkenau (DE)

(73) Assignee: WERKZEUGBAU SIEGFRIED HOFMANN GMBH, Lichtenfels (DE)

(21) Appl. No.: 16/639,224

(22) PCT Filed: Dec. 15, 2017
(86) PCT No.: PCT/EP2017/083111

§ 371 Date: Feb. 14, 2020

(30) Foreign Application Priority Data
Aug. 18, 2017 (DE) 10 2017 118 960.2

(51) Int. Cl. B29C 64/118; B29C 44/58; B29C 64/30; B29C 59/00; B29C 59/02

(52) U.S. Cl. CPC B29C 64/118; B29C 44/58; B29K 2105/048; B29C 59/005; B29C 59/02; B29C 64/30

(57) ABSTRACT

A foaming tool for processing foamable plastic particles, having at least one region that forms at least one portion of a cavity, at least one part of a surface structure of the region that forms the cavity being produced by an additive manufacturing method.

The invention relates to a foaming tool for processing foamable plastics particles, comprising at least one region that forms at least one portion of a cavity.

Foaming tools of this kind are well-known from the prior art. Said tools are used for producing or shaping molded parts consisting of foamable plastics particles, for example as molded part machines. Molded part machines of this kind comprise at least one foaming tool, such that they comprise for example two plates that can be moved towards one another and away from one another in a stroke-like manner. A cavity thus forms between foaming tools of this kind, which cavity specifies a mold cavity in which the foamable plastics particles can be shaped. Within the context of this application, a foaming tool can also be understood as a tool that forms a portion of a cavity.

For the purpose of production, the foamable and/or pre-foamed plastics particles are introduced into the cavity and formed into the original volume thereof by swelling or expansion, for example by means of hot vapor. It is thus possible to also use materials that do not comprise any active blowing agent. In this case, the surface or the surface structure of the cavity specifies the surface structure of the molded part, which structure said molded part has following production. In this case it is possible to select the surface of the cavity in accordance with the requirements for the surface of the molded part produced thereby, such that, following demolding, the molded part has the corresponding surface shaped by the foaming tool.

When producing foaming tools or this kind, or the surface structures thereof, it is known to introduce surface structures into the surface of the foaming tools by means of subtractive methods such as milling, electrical discharge machining, etching or laser ablation. Furthermore, reshaping methods such as stamping are known. A disadvantage in this case is that material is lost due to the subtractive or reshaping method. The foaming tools therefore have to be produced having an excess which must subsequently be removed or reshaped.

Furthermore, the known method is restrictive with respect to the reproducible geometries or surface structures of the surface of the foaming tools.

The object of the invention is therefore that of specifying a foaming tool that is improved in comparison therewith.

The object is achieved by a foaming tool of the type mentioned at the outset, in which, according to the invention, the features of claim 1 are provided.

The invention is therefore based on the finding that the surface structure or at least a part of the surface structure of the region forming the cavity is produced by means of an additive method. It is thus possible to build up the surface structure in an additive manner, such that no subtractive or reshaping finishing process is required in order to introduce the desired surface structure into the foaming tool or provide the foaming tool with the corresponding surface structure.

This ensures that the material scrap can be reduced, since in the additive method merely the material that is necessary for forming the surface structure is additively applied to the workpiece or the surface that is provided. It is thus possible to produce foaming tools having a finished final contour or at least so as to be close to the final contour. Of course, this does not exclude the possibility, however, that a surface structure produced by means of an additive method can be post-processed.

In addition, surface structures can be achieved which cannot be produced using conventional manufacturing methods or processes. The restrictions of the previous methods relating to the surface structure of the region forming the cavity do not exist in additive methods, and therefore there is a plurality of options for forming the surface structure of the foaming tool. In this case in particular surface structures are possible that are not accessible to subtractive or reshaping methods. It is thus possible, for example, to produce structures, for example channels, that are close to the surface, i.e. close under the surface of the region forming the cavity, such that more direct temperature control of the cavity is possible. Closed channels of this kind that are provided close to the surface, on the cavity, cannot be achieved using reshaping or subtractive production methods.

In this case, the additive production of the surface structure can relate to the overall cavity or only to a portion of a cavity that is formed by the foaming tool. In addition, it is also possible to produce only a sub-region of the surface structure of the surface of the foaming tool, defining the cavity, by means of an additive method.

All suitable foamable plastics particles, for example thermoplastic polymers, in particular based on polyolefin or polystyrene, can be used as plastics particles for producing the molded part. The molded part is shaped by sintering the plastics particles.

It is thus possible, according to the invention, to additively produce structures in the surface of the region forming the cavity, in order that, as a result, finishing steps are no longer required. It is thus possible, for example, to apply shapes and logos for example to the workpiece to be produced, which shapes and logos consist of small structures, for example small letters or characters. Generally, “imprinting” small structures of this kind, which are thus impressed in negative into the surface of the workpiece to be produced, is not possible or not economic, since it would be necessary to remove the entire surface around the mentioned surface structure, for example by means of milling, etching or by laser ablation. In contrast, according to the invention it is possible to produce a surface structure of the cavity in a generative manner, in order to thus additively apply to the surface of the region forming the cavity only the structures required for the imprinting, such that said structures can be impressed into the surface of the workpiece. A finishing process is not required according to the invention, since the surface structure can be produced having the finished final contour or at least so as to be close to the final contour.

As a result, the foaming tool according to the invention allows for novel design options, such that it is possible for example to additively produce surface structures defining the surface of the workpiece, which structures cannot be (economically) achieved using conventional production methods known in the prior art. In this case it is possible, in particular with respect to visible components, to achieve a specific surface quality, for example to conceal air pockets or grain boundaries between the particles, by means of imprinting a particular surface structure. The term “surface structure” can for example relate to a defined topography in the surface of the workpiece, and thus purposely differ from a “smooth” surface; in particular, additively produced elevations and/or depressions or any corresponding pattern of elevations and depressions can be provided in the surface structure or formed by the surface structure. The surface structure can thus relate to a surface that is structured in a defined manner, which surface in particular comprises any desired pattern.

According to a preferred embodiment of the invention, it is possible for the at least one part of the surface structure to be produced by means of laser melting and/or binder jetting and/or electron-beam melting and/or fused deposition modelling and/or laser metal deposition. Accordingly, the above-mentioned methods are suitable in particular for producing at least one part of the surface structure of the region forming the cavity, wherein, in order to form the surface structure, material is selectively applied and is solidified. As a result, it is possible to create any desired surface structures that cannot be achieved using conventional production methods. Within the context of this application, binder jetting is understood to be a production method in which in particular powdered structural material is at least partially fixed using a binder. The fixed structural material can subsequently be sintered for example. Production methods of this kind are also known as “inkjet technology”.

In this case, it is particularly preferable for the at least one part of the surface structure to be produced from an in particular powdered construction material that can be solidified by an energy beam, by means of successive layered selective exposure, and associated successive layered selective solidification of construction material layers. According thereto the at least one part of the surface structure is produced by means of layered solidification of mostly powdered construction material. In this case, in an alternating manner, a layer of construction material is applied, and this is subsequently solidified, in the desired regions, by an energy beam. As a result, the desired surface structure that is built up by the additive production method develops layer-by-layer.

It is furthermore possible, during production of the foaming tool according to the invention, for the at least one part of the surface structure to be produced directly, together with the production of the tool, or to be produced subsequently. It is accordingly possible, according to a first alternative, for the foaming tool that forms at least one portion of the cavity or that comprises a region that forms at least one region of the cavity to likewise be produced by means of an additive production method. In this case, the surface structure of the region forming the cavity, or at least a part thereof, is produced or formed together with the production of the foaming tool.

According to a second alternative, it is likewise possible, in the case of an existing foaming tool, to change the existing surface structure by means of an additive production method, or to apply a surface structure to the surface of the previously produced tool. Accordingly, the foaming tool can consist of a prefabricated main body, to which at least a part of the surface structure is applied by the additive method. It is thus possible to supplement, by means of an additive method, in particular structures that are not accessible for conventional production methods.

In this case it is preferably possible for at least one part of a surface structure of the region forming the cavity to be formed separately from the foaming tool and to be connectable or connected to the region. According to this embodiment of the foaming tool according to the invention, at least one part of a surface structure of the region forming the cavity can be formed or produced separately from the remainder of the foaming tool. The at least one part of the surface structure of the region forming the cavity can thus be introduced into the foaming tool, in order to subsequently produce corresponding molded parts, which are intended to be provided with the desired surface structure, using the foaming tool.

It is particularly preferably possible, in the foaming tool according to the invention, for the at least one part to be designed as an insert which is or can be placed into a corresponding recess. In this case it is possible in particular to switch the corresponding regions or parts of the surface structure of the foaming tool, such that different surface structures can be created using the same foaming tool. For this purpose, it is possible, for example, for inserts to be provided that are produced in an additive manner and have a particular, defined surface structure. Introducing an insert of this kind into the foaming tool makes it possible to produce various molded parts having different surface structures. In this case, the various inserts can be switched if molded parts having a different surface structure are intended to be manufactured using the same foaming tool.

The foaming tool according to the invention can furthermore be developed in that the at least one part of the surface is applied retrospectively to an existing component, or an existing surface structure is supplemented by the at least one part. Thus, according to this embodiment of the invention, a type of hybrid structure is proposed, in which a defined surface structure is applied to an existing foaming tool or an existing surface structure is supplemented accordingly. As a result, it is possible to combine different production methods, such that a part of the foaming tool can be produced using conventional methods, and only region or parts of the surface or of the surface structure which cannot be produced by conventional methods, for example, are produced using additive methods. Of course, in this case the proportion of the production performed by additive production methods can be selected as desired.

According to a further preferred embodiment of the foaming tool according to the invention, it may be possible for at least one item of information relating to the at least one part of the surface structure to be generated by means of CAD (computer aided design) or by means of at least one machine parameter. The at least one item of information can particularly preferably be used for describing the surface structure, for example to specify or create a geometrical or three-dimensional model of the surface structure that the foaming tool is intended to comprise. It is likewise possible to create the desired surface structure by means of suitable adjustment of structure-forming machine parameters.

According to a further preferred embodiment of the foaming tool according to the invention, it may be possible for the at least one part of the surface structure to be finished by means of at least one method step, preferably by means of an abrasive method and/or laser ablation and/or a chemical or electrical smoothing method and/or a compressing or microshaping method. According thereto, the at least one part of the surface structure which was produced additively according to the invention can be finished accordingly. The surface structure or the surface of the foaming tool can be machined in a defined manner by means of the finishing process or the at least one method step for finishing, such that the surface has a defined quality. In particular irradiation of the surface by means of glass beads can be used as the compressing or microshaping method.

According to a preferred embodiment, the at least one part of the surface structure of the region forming the cavity comprises at least two sub-regions having different surface structures. According to this embodiment it is thus possible to additively produce a part of the surface structure of the region forming the cavity, wherein the surface structure is formed differently in at least two sub-regions of the part. It is thus possible in particular to produce different sub-regions that differ with respect to the surface structure thereof.

According thereto, any desired surface structures can be formed, which surface structures are subsequently transferred onto the molded part during the production thereof.

The foaming tool according to the invention can furthermore be developed in that the surface structure forms at least one elevation and/or at least one depression in the surface of the foaming tool, or comprises such an elevation and/or depression. Therefore, in contrast to subtractive methods, in addition to forming a depression in the surface of the foaming tool it is also possible to apply an elevation. Of course, it is possible for both the application of the elevation and the formation of a depression to be combined with one another as desired, such that the resulting surface structure can be formed both so as to be elevated, and so as to be depressed, relative to the foaming tool.

A development of the foaming tool according to the invention can furthermore consist in the at least one part comprising a surface structure such that a product produced by means of the foaming tool can be provided with at least one item of information during production. The at least one item of information can for example be or contain a motif or lettering, in particular relating to the production of the molded part. It is thus possible, for example, to integrate a sign of the manufacturer or a production date or a batch number into the surface structure, such that the produced product also carries the information on the surface structure thereof.

In addition, the invention relates to a method for producing a foaming tool according to the invention comprising at least one region that forms at least one portion of a cavity. Of course, all the advantages, details and features relating to the foaming tool according to the invention can be transferred to the method according to the invention.

In the method according to the invention, the at least one part of the surface structure is particularly preferably produced from an in particular powdered construction material that can be solidified by an energy beam, by means of successive layered selective exposure, and associated successive layered selective solidification of construction material layers. Therefore, in the production method according to the invention, an in particular powdered construction material is applied in layers and subsequently exposed to an energy beam and solidified thereby. As a result of the selective exposure or solidification of the construction material, the desired surface structure is formed in a layered manner.

According to a preferred embodiment of the method according to the invention, it may be possible for the at least one part of the surface to be applied retrospectively to an existing component, or for an existing surface structure to be supplemented by the at least one part. According thereto it is possible to design the foaming tool, according to the production method, as a hybrid component, wherein the desired surface structure or a part thereof is applied retrospectively to the existing component or semi-finished product. It is likewise possible for the foaming tool to already comprise a defined surface structure which is supplemented by the at least one part of the desired surface structure, by means of the additive production method. As a result, a combination of conventional production methods and additive production methods is possible.

The invention will be explained in greater detail in the following, on the basis of embodiments and with reference to the drawings. The drawings are schematic views, in which:

FIG. 1 shows a foaming tool according to the invention according to a first embodiment;

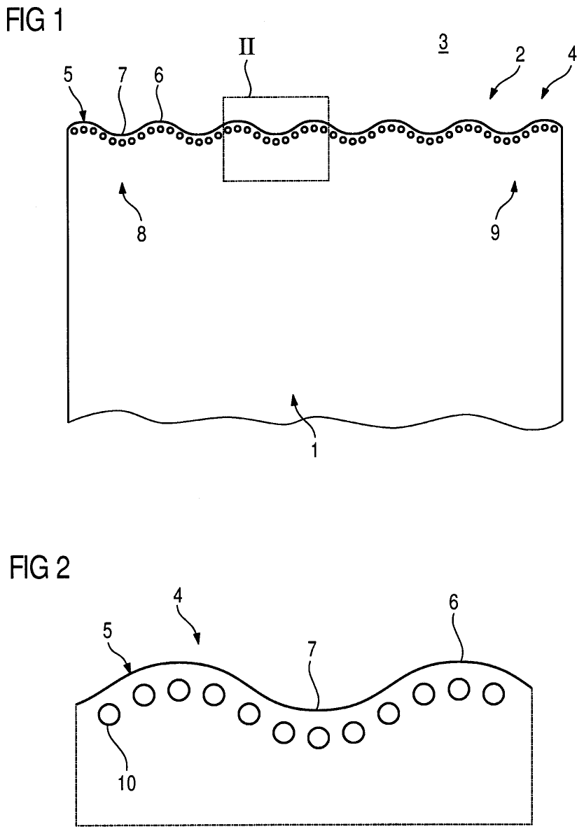

FIG. 2 is the section II-II of the foaming tool according to the invention from FIG. 1;

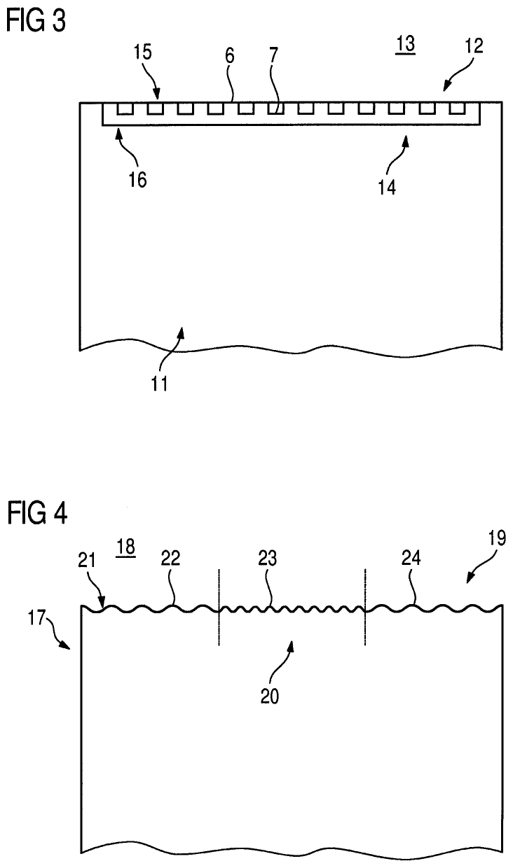

FIG. 3 shows a foaming tool according to the invention according to a second embodiment; and

FIG. 4 shows a foaming tool according to the invention according to a third embodiment.

FIG. 1 shows a foaming tool 1 for processing foamable or prefoamed plastics particles. The foaming tool 1 comprises a region 2 that forms a portion of a cavity 3 or defines the cavity 3. According to the first embodiment shown in FIG. 1, the region 2 forming the cavity 3 comprises a part 4 having a surface structure 5 that is produced by means of an additive method. According to this embodiment, the surface structure 5 is produced by means of laser melting, wherein the surface structure 5 is produced from an in particular powdered construction material that can be solidified by an energy beam, by means of successive layered selective exposure, and associated successive layered selective solidification of construction material layers. Of course, all other additive production methods can be used for producing the foaming tool 1.

In the embodiment of the foaming tool 1 shown in FIG. 1, the surface structure 5 can be produced directly, together with the production of the remainder of the foaming tool 1. An alternative separate production of the surface structure is shown for example in the second embodiment, with reference to FIG. 3.

The surface structure 5 comprises a plurality of elevations 6 and a plurality of depressions 7 which are produced by means of the additive production method.

Furthermore, the surface structure 5 comprises two sub-regions 8, 9, wherein the surface structure 5 is shaped differently in the two sub-regions 8, 9. The two sub-regions 8, 9 accordingly have a differently designed surface structure 5.

The region II-II from FIG. 1 is shown enlarged in FIG. 2. It is clear that the surface structure 5 is formed by alternately arranged elevations 6 and depressions 7. It is furthermore clear that the surface structure 5 comprises channels 10 that are close to the surface and through which for example a working fluid can be conveyed, in order to control the temperature of the molded part. The arrangement of the channels 10 close to the surface is made possible by the use of the additive production method, wherein this would not be achievable by means of conventional production methods.

FIG. 3 shows a foaming tool 11 according to a second embodiment. The foaming tool 11 comprises a region 12 that forms a portion of a cavity 13. The region 12 comprises a part 14 having a surface structure 15 that is produced by means of an additive production method. The surface structure 15 likewise comprises elevations 6 and depressions 7.

The part 14 is designed as an insert and is inserted into a corresponding recess 16 in the foaming tool 11. Of course, the part 14 is detachable and can therefore be removed from the foaming tool 11. As a result, different inserts can be received in the recess 16, and therefore different surface structures 15 can be introduced into the foaming tool 11, or the part 14 can be exchanged.

FIG. 4 shows a foaming tool 17 according to a third embodiment. The foaming tool 17 comprises a region 19 that forms a portion of a cavity 18, which region comprises at least a part 20 of a surface structure 21. In this case, the part 20 of the surface structure 21 is produced by an additive method. Therefore, the foaming tool 17 according to the embodiment shown in FIG. 4 comprises three sub-regions 22 to 24, wherein the surface structure 21 in the sub-regions 22 and 24 is the same, and differs from the part 20 of the surface structure 21 in the sub-region 23. In other words, the surface structure 21 in the sub-regions 22 and 24 differs from the surface structure 21 in the region 24.

The surface structure 21 in the sub-regions 22 and 24 was produced together with the remainder of the foaming tool 17, directly during production thereof. The part 20 of the surface structure 21 in the sub-region 23 was applied retrospectively by means of an additive method. In other words, the surface structure 21 was supplemented by the sub-region 23.

Of course, the individual designs that are shown in the individual embodiments can be combined with one another as desired. In particular, any of the embodiments shown can be provided with channels 10. It is likewise also possible to divide the individual surface structures 5, 15, 21 as desired into sub-regions or to form these directly together with the individual foaming tools 1, 11, 17 or retrospectively and/or separately therefrom, for example as inserts.

### LIST OF REFERENCE SIGNS

1 foaming tool
2 region
3 cavity
4 part
5 surface structure
6 elevation
7 depression
8 sub-region
9 sub-region
10 channel
11 foaming tool
12 region
13 cavity
14 part
15 surface structure
16 recess
17 foaming tool
18 cavity
19 region
20 part
21 surface structure
22 sub-region
23 sub-region
24 sub-region

1. A foaming tool for processing foamable plastics particles, comprising at least one region that forms at least one portion of a cavity, wherein at least one part of a surface structure of the region forming the cavity is produced using an additive method.

2. The foaming tool according to claim 1, wherein the at least one part of the surface structure is produced using laser melting and/or binder jetting and/or electron-beam melting and/or fused deposition modelling and/or laser metal deposition.

3. The foaming tool according to claim 1, wherein the at least one part of the surface structure is produced from an in particular powdered construction material that can be solidified by an energy beam, using successive layered selective exposure, and associated successive layered selective solidification of construction material layers.

4. The foaming tool according to claim 1, wherein the at least one part is designed as an insert which is or can be placed into a corresponding recess.

5. The foaming tool according to claim 1, wherein the at least one part of the surface structure is produced directly together with the production of the foaming tool or is produced retrospectively.

6. The foaming tool according to claim 1, wherein at least a part of a surface structure of the region forming the cavity is formed separately from the foaming tool and can be or is connected to the region.

7. The foaming tool according to claim 1, wherein the at least one part of the surface structure is applied retrospectively to an existing component, or an existing surface structure is supplemented by the at least one part.

8. The foaming tool according to claim 1, wherein at least one item of information relating to the at least one part of the surface structure can be generated using CAD or using at least one machine parameter.

9. The foaming tool according to claim 1, wherein the at least one part of the surface structure is finished using an abrasive method and/or laser ablation and/or a chemical or electrical smoothing method and/or a compressing or microshaping method.

10. The foaming tool according to claim 1, wherein the at least one part comprises at least two sub-regions having different surface structures.

11. The foaming tool according to claim 1, wherein the surface structure forms at least one elevation and/or at least one depression in the surface of the foaming tool, or comprises an elevation and/or depression of this kind.

12. The foaming tool according to claim 1, wherein the at least one part comprises a surface structure such that a product produced using the foaming tool can be provided with at least one item of information during production.

13. A method for producing a foaming tool according to claim 1, comprising at least one region that forms at least one portion of a cavity.

14. The method according to claim 13, wherein the at least one part of the surface structure is produced from an in particular powdered construction material that can be solidified by an energy beam, using successive layered selective exposure, and associated successive layered selective solidification of construction material layers.

15. The method according to claim 13, wherein the at least one part of the surface structure is applied retrospectively to an existing component, or an existing surface structure is supplemented by the at least one part.
